(19) United States
(12) Patent Application Publication
(10) Pub. No.: US 2004/0174238 A1
(43) Pub. Date: Sep. 9, 2004

(54) A PLUGBOARD FOR HOUSING SOCKETS AND MICRO-RELAYS

(75) Inventors: Montserrat Pinol Pedret, Tarragon Valls (ES); Jose Maria Pares Caselles, Tarragon Valls (ES)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/707,929

(22) Filed: Jan. 26, 2004

(30) Foreign Application Priority Data
Mar. 6, 2003 (WO) WO 03/019732

(51) Int. Cl. H01H 67/02

(52) U.S. Cl. 335/128

(57) ABSTRACT

A plugboard for housing sockets and micro-relays, of the type used for housing a plurality of connectors, sockets or micro-relays, which is composed of a base (1) and a plurality of holes for housing connectors, sockets or micro-relays (2), said holes not being aligned with each other and with the position of alternating holes for introducing the connector, socket or micro-relay rotated 180° with regard to the position of the remaining holes intended for housing the connectors, sockets or micro-relays of the ends of the plugboard.

### BACKGROUND OF INVENTION

1. Object of the Invention

The present invention, a plugboard for housing sockets and micro-relays, consists of a multiple terminal connector plugboard structure for carrying out electrical inter-connections. This device will be especially useful in certain applications, particularly in the automobile sector, where reliability as well as quickness in carrying out the inter-connections are required, requiring a special design and concept of the connector devices used.

It is because of this that the present invention will be of special interest for the manufacturing and supply sector of electric connection equipment, and in auxiliary devices used for the automobile industry.

2. Description of the State of the Art

Currently, quickly and easily carrying out electric inter-connections is a requirement in most of the auxiliary industries, where a required reduction of assembly times has promoted the development of new types of connectors. Said connectors are fundamentally based on the constitution of connection boxes, which can be fitted together, provided with closure and clamping flanges between both plug tap and socket parts of the connectors. Likewise, carrying out the connection is done so by over-coming a specific pressure of said flanges, which cause the coupling of both plug tap and socket parts, the connection thereby being carried out.

For housing certain electric devices, the connectors, sockets or micro-relays, plugboards are used, by means of which the placement and connection thereof are facilitated, acting as physical protection of the terminals of the elements connected to them.

Traditionally the connection of the sockets or micro-relays to the plugboard is done by inserting them in aligned holes and with determined plugboard dimensions, always under conditions of lack of space conditioned by the necessity of the saving thereof. The fixing to the plugboard is carried out by means of two pins each in wedge form, each one placed on opposite sides of the socket or micro-relay. In the case of a plugboard intended for housing three sockets or micro-relays with aligned holes intended for housing them, only the central socket or micro-relay is fixed to the plugboard by both pins because it can open both pins due to the composition of the plugboard and the arrangement of the holes. The other two side holes, due to the lack of space, would only permit one of the sockets or micro-relay pins to be opened, giving way to a lack of stability in the connection and bad contact between electric components.

### DESCRIPTION

As a result of all this, the plugboard for housing sockets and micro-relays which is illustrated in the present description is basically constituted of a plugboard of the ones used for housing connectors, sockets or micro-relays, composed of a base and a plurality of connectors. The distribution of said connectors, such that the connection is ensured with the traditionally used means, consists of arranging the holes intended for housing the connectors, instead of the traditionally aligned form, by shifting alternating holes, one hole or housing shifted every two holes, and varying the position in 180° of each one of the previously shifted holes or housings.

In this form and on shifting and varying the position of the alternating hole, one for every two holes, in the plugboard itself, all of the connector pins, usually two, can be opened on the inside thereof, ensuring the connection between plugboard and connectors housed in it and permitting a suitable fluidity of the electric flux between the different parts.

### BRIEF DESCRIPTION OF DRAWINGS

In order to facilitate the understanding of the plugboard for housing sockets and micro-relays, two drawings are attached to the present patent application whose purpose is a better understanding of the principles on which the invention concerning us is based, and the better understanding of the description of a preferred embodiment form, taking into account that the character of the drawings is illustrative and non-limiting.

FIG. 1: shows a perspective view of a plugboard for housing sockets and micro-relays with a detail of the distribution of the connectors to the plugboard.

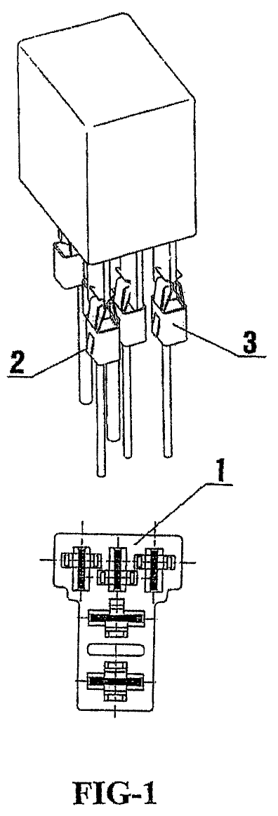

FIG. 2: Shows a cross section view of a plugboard for housing sockets and micro-relays with these latter being inserted.

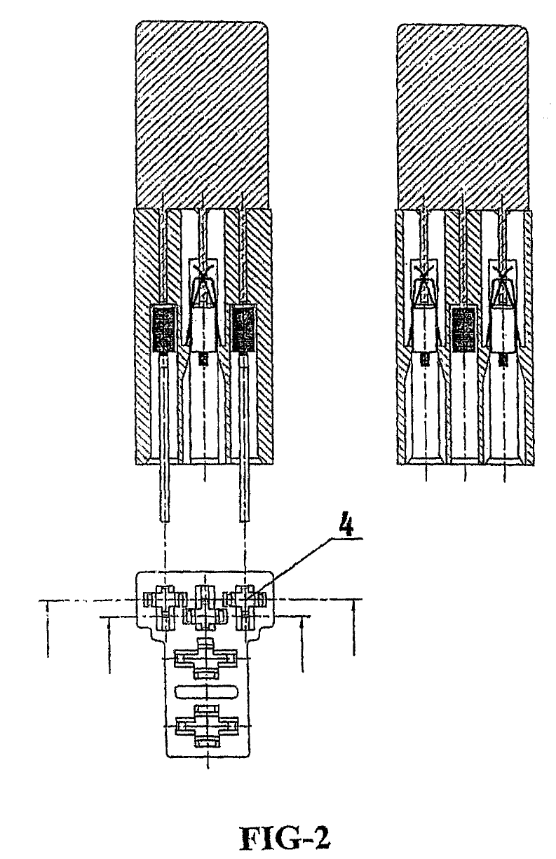

### DETAILED DESCRIPTION

According to the embodiment example shown, the plugboard for housing sockets and micro-relays illustrated in this preferred embodiment form is basically constituted by a plugboard with the traditional dimensions of the ones used for housing connectors, sockets or micro-relays, composed of a base (1) and a plurality of connectors (2). The distribution of the connectors (2), ensuring the connection with traditionally used means with no need to modify the design of the traditional connectors, sockets or micro-relays, is provided with three holes intended for housing the connectors (2), instead of the traditionally aligned holes, their position being shifted and varying, specifically the position of the central hole intended for housing the central connector.

On the other hand, in the plugboard itself, the two pins (3) of the connectors (2) can be opened, ensuring the connection between plugboard and connectors housed in it.

Within its essentiality, the invention can be carried out in practice in other embodiment forms which differ only in details from the embodiment indicated as an example. The invention can be carried out in any shape and size, with the most suitable means and materials and with the most suitable accessories, it being possible to substitute the component elements with other, technically equivalent ones, all of which is comprised within the claims.

1. A plugboard for housing sockets and micro-relays, of the type used for housing a plurality of connectors, sockets or micro-relays, composed of a base (1) and a plurality of holes for housing connectors, sockets or micro-relays (2), characterized in that said holes are not aligned with each other and with the position of alternating holes for introducing the connector, socket or micro-relay rotated 180° with regard to the position of the remaining holes intended for housing the connectors, sockets or micro-relays of the ends of the plugboard.

2. A plugboard for housing sockets and micro-relays according to claim 1, characterized in that it is provided with three holes for housing three connectors, sockets or micro-relays, wherein the central hole intended for housing a connector, socket or micro-relay is not aligned with regard to the two holes intended for housing the connectors, sockets or micro-relays of the ends of the plugboard and with the position for introducing the connector, socket or micro-relay rotated 180° with regard to the position of the two holes intended for housing the connectors, sockets or micro-relays of the ends of the plugboard.

3. A plugboard for housing sockets and micro-relays according to claims 1 and 2, characterized in that in each one of the holes of the plugboard, all the pins (3) of the connectors, sockets, or micro-relays (2) can open, ensuring the connection between plugboard and connectors, sockets or micro-relays introduced in said holes.
